(19) United States
(12) Patent Application Publication
(10) Pub. No.: US 2010/0271823 A1
(43) Pub. Date: Oct. 28, 2010

(54) HEAT DISSIPATION DEVICE AND ILLUMINATION DEVICE USING SAME

(75) Inventors: HSIN-FEI HUANG, Chu-Nan (TW); ZHENG-JAY HUANG, Chu-Nan (TW); CHIEN-TING LU, Chu-Nan (TW); YING-CHING CHEN, Chu-Nan (TW); YU-PIN LIU, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/699,981

(22) Filed: Feb. 4, 2010

(30) Foreign Application Priority Data
Apr. 23, 2009 (CN) 200910301794.4

(51) Int. Cl. F21S 4/00

(52) U.S. Cl. 362/249.02

(57) ABSTRACT

An exemplary heat dissipation device includes an elongated main body, a number of heat sinks, and a number of airflow channels. The main body has a central axis, and includes a first portion and a second portion. The second portion has an end distant from the first portion which is configured for supporting at least one item selected from the group consisting of a solid-state light source and a circuit board having a solid-state light source mounted thereon. The heat sinks are arranged around the first portion in sequence along the central axis of the main body, and spaced from one another. Each heat sink includes a number of fins extending out from the first portion radially. The airflow channel is defined between each two neighboring heat sinks.

### BACKGROUND

1. Technical Field

The disclosure generally relates to heat dissipation devices, and particularly to a heat dissipation device for efficiently dissipating heat from components such as illuminators.

2. Description of Related Art

Light emitting diodes (LEDs) are currently used extensively as light sources for illumination devices due to their high luminous efficiency, low power consumption and long life span.

The stability of light emitted by LEDs is affected by heat generated by the LEDs. When the temperature of an LED is too high, the light intensity of the LED may gradually attenuate, and the life span of the illumination device is liable to be shortened.

Therefore, what is needed is a heat dissipation device that overcomes the described limitations.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the various views.

FIG. 1 is an isometric view of a first embodiment of an illumination device utilizing a heat dissipation device.

FIG. 2 is a side plan view of a second embodiment of an illumination device utilizing a heat dissipation device.

FIG. 3 is an isometric view of a third embodiment of an illumination device utilizing a heat dissipation device.

### DETAILED DESCRIPTION

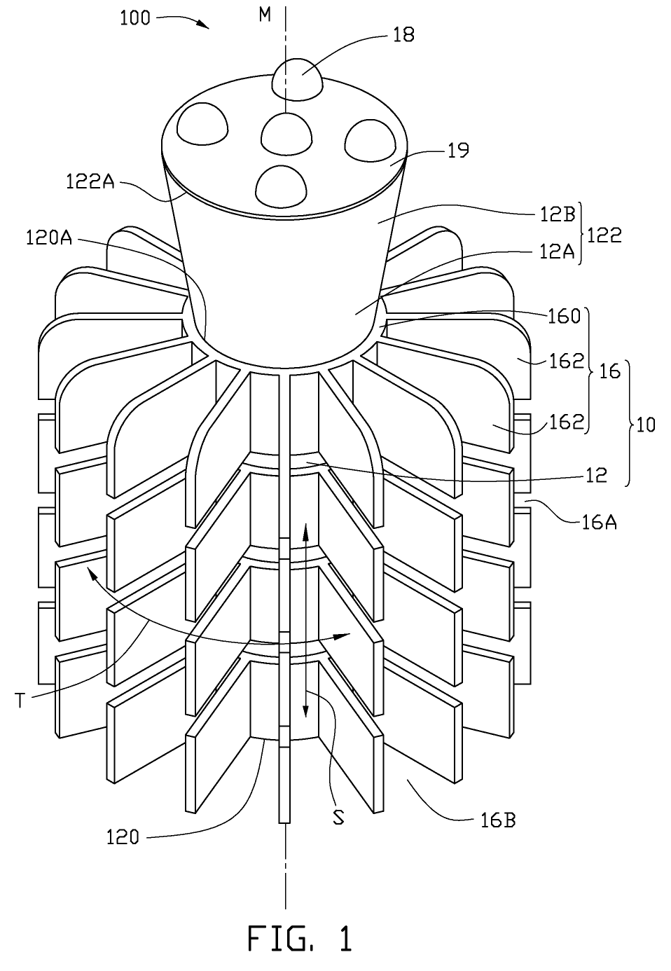

Referring to FIG. 1, a first embodiment of an illumination device 100 includes a heat dissipation device 10 and at least one solid-state light source 18 mounted thereon. The heat dissipation device 10 dissipates heat from the at least one solid-state light source 18.

The heat dissipation device 10 includes an elongated main body 12, and a plurality of heat sinks 16.

The main body 12 has a central axis M, and includes a first portion 120 receiving the heat sinks 16. The first portion 120 has a first end 120A. Each heat sink 16 includes a cylindrical (or annular) sleeve 160, and a plurality of fins 162 extending out from the sleeve 160 radially. Preferably, the fins 162 are evenly spaced apart from each other around the sleeve 160. The heat sinks 16 are arranged around the first portion 120 in sequence along the central axis M of the main body 12, and are spaced from one another. The sleeve 160 of each heat sink 16 has an inner surface (not labeled) snugly contacting a peripheral surface of the first portion 120. The fins 162 thus surround not only the sleeve 160, but also the first portion 120 of the main body 12.

The at least one solid-state light source 18 may be arranged on the first end 120A. However, in this embodiment, the main body 12 advantageously further includes a second portion 122 extending up from the first end 120A of the first portion 120. The second portion 122 has a second end surface 122A, which is distant from the first portion 120. The second surface 122A may be larger than a corresponding horizontal dimension of the first end 120A. Thereby, more than one solid-state light source 18 can be arranged on (or above) the second surface 122A. In the embodiment shown in FIG. 1, the first portion 120 is cylindrical, and the second portion 122 is frustoconical (a truncated circular cone). The second portion 122 includes a first end 12A adjoining (or connecting with) the first portion 120, and a second end 12B distant from the first portion 120. The second portion 122 tapers from top to bottom, and so the second end 12B is larger than the first end 12A. Five solid-state light sources 18 can be arranged on (or above) the second end surface 122A of the second end 12B. In alternative embodiments, either or both of the first portion 120 and the second portion 122 may have other shapes. For example, the first portion 120 may be prism-shaped, and the second portion 122 may be prismoid shaped.

The solid-state light sources 18 can be LEDs, or other suitable kinds of light sources. The illumination device 100 may further include a circuit board 19, such as a printed circuit board. The circuit board 19 supports the solid-state light sources 18 thereon. The circuit board 19 can be disposed on the second end surface 122A to thereby contact the second portion 122 of the main body 12.

The main body 12 and the heat sinks 16 may be made of metal with high thermal conductivity, such as copper, aluminum, copper-aluminum alloy, or other suitable metal or alloy. In operation, heat from the solid-state light sources 18 is transferred in sequence from the circuit board 19 to the second portion 122 and to the first portion 120. The heat is further transferred from the first portion 120 to the fins 162 through the sleeves 160. The fins 162 provide a large surface area in contact with ambient air. Thus a large amount of heat can be dissipated from the solid-state light sources 18.

One advantage of the illumination device 100 is that the heat sinks 16 are spaced from one another. Accordingly, a plurality of first airflow channels T are formed in a plurality of gaps 16A between each two neighboring heat sinks 16. The first airflow channels T surround the first portion 120 and allow air to flow therethrough. Thus the heat at the fins 162 can be efficiently dissipated. Another advantage is that the solid-state light sources 18 are arranged at the second surface 122A distant from the first portion 120. If the heat accumulated at the heat sinks 16 is not dissipated promptly, heat from the solid-state light sources 18 can still be dissipated directly from the second portion 122.

The heat sinks 16 can be arranged to have optimized heat dissipation performance. For example, the number of fins 162 of each heat sink 16 may be the same as the number of fins 162 of each other heat sink 16. With such configuration, each fin 162 of each heat sink 16 may be aligned with a corresponding fin 162 of a neighboring heat sink 16 along a vertical direction parallel to the axis M of the main body 12. Thus a plurality of second airflow channels S may be formed in gaps 16B between the fins 162. Each second airflow channel S extends along a series of the gaps 16B in a vertical direction parallel to the axis M of the main body 12. The second airflow channels S intersect with the first airflow channels T and allow air to flow therethrough. Thus the heat in and around the heat sinks 16 can be dissipated more efficiently.

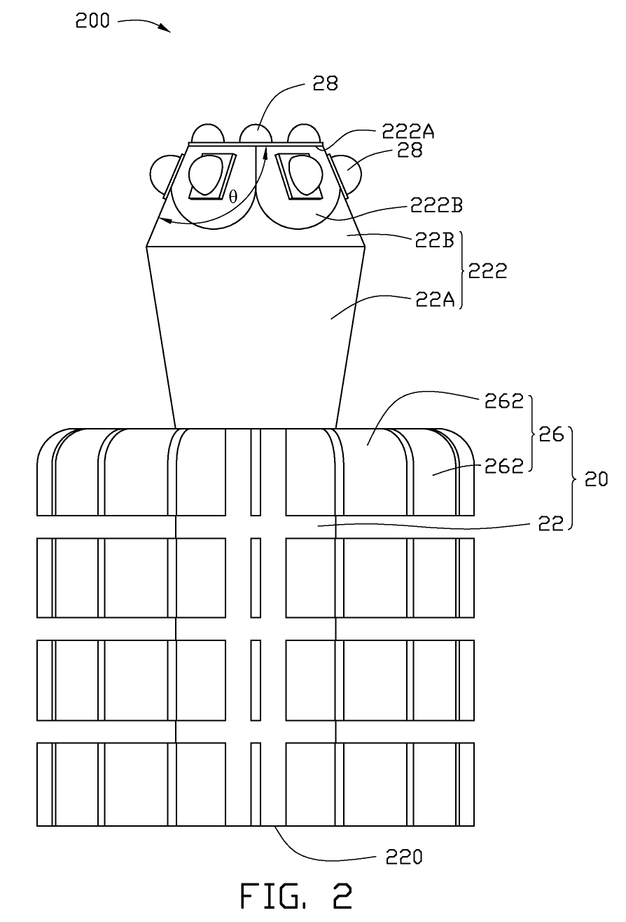

FIG. 2 is a side plan view of a second embodiment of an illumination device 200. The illumination device 200 includes a heat dissipation device 20, and a plurality of solid-state light sources 28.

The heat dissipation device 20 is similar to the heat dissipation device 10 of the first embodiment. The heat dissipation device 20 includes an elongated main body 22, and a plurality of heat sinks 26. The elongated main body 22 includes a first portion 220 and a second portion 222. The second portion 222 includes a first section 22A extending up from the first portion 220, and a second section 22B distant from the first portion 220. The heat dissipation device 20 differs from the heat dissipation device 10, inter alia, in that each of the heat sinks 26 includes a plurality of fins 262 extending directly from the main body 22. In addition, the second portion 222 differs from the second portion 122 in structure. The first section 22A is circular frustoconical, and tapers downwardly. The second section 22B is generally circular frustoconical, and tapers upwardly. The second section 22B has a second end surface 222A and a plurality of planar side surfaces 222B. Each of the side surfaces 222B adjoins the second end surface 222A, and the side surfaces 222B surround the second end surface 222A. An obtuse angle θ is defined between each side surface 222B and the second end surface 222A. The side surfaces 222B cooperate with the second end surface 222A to provide space for the solid-state light sources 28 to be arranged thereon or thereat. In the illustrated embodiment, each of the side surfaces 222B supports a circuit board (not labeled) that has one solid-state light source 28, and the second end surface 222A supports a circuit board (not labeled) that has, for example, five solid-state light sources 28. Thus a radiating range of the illumination device 200 is increased.

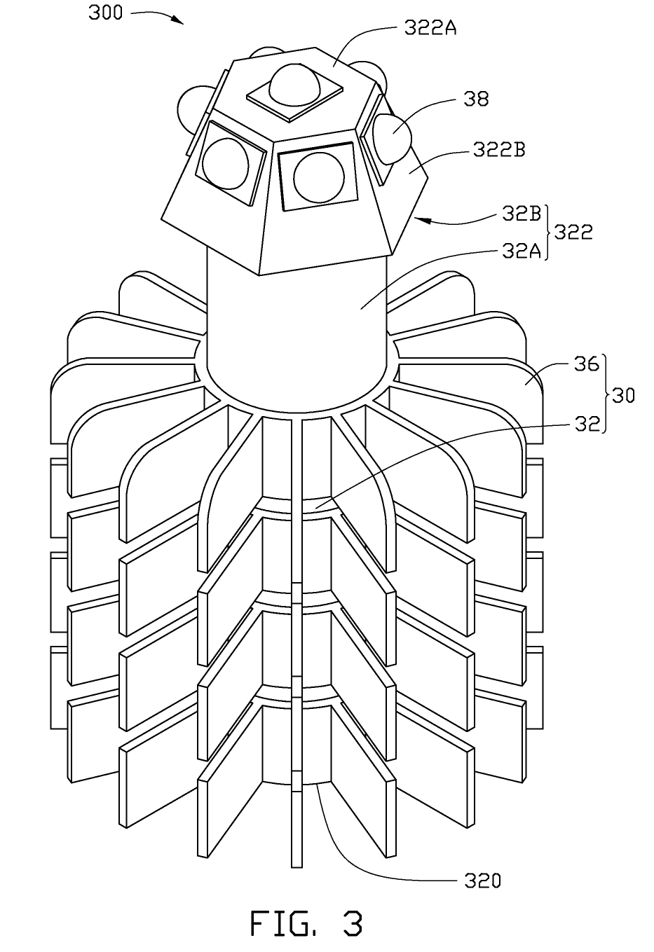

FIG. 3 shows a third embodiment of an illumination device 300. The illumination device 300 includes a heat dissipation device 30, and a plurality of solid-state light sources 38.

The heat dissipation device 30 is similar to the heat dissipation device 20 of the second embodiment. The heat dissipation device 30 includes an elongated main body 32, and a plurality of heat sinks 36. The elongated main body 32 includes a first portion 320 and a second portion 322. The second portion 322 includes a first section 32A and a second section 32B. The heat dissipation device 30 differs from the heat dissipation device 20, inter alia, in that the first section 32A is cylindrical, and the second section 32B is hexagonally frustoconical (i.e., prismoid). The second section 32B tapers upward. A diameter of a bottom of the second section 32B is larger than a diameter of the first section 32A. Similar to the heat dissipation device 20, the second section 32B of the second portion 322 has a second end surface 322A and a plurality of planar side surfaces 322B. The side surfaces 322B cooperate with the second end surface 322A to provide space for the solid-state light sources 38 to be arranged thereon or thereat. In the illustrated embodiment, each of the side surfaces 322B supports a circuit board (not labeled) that has one solid-state light source 38, and the second end surface 322A supports a circuit board (not labeled) that has, for example, one solid-state light source 38. Thus a radiating range of the illumination device 300 is increased.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An illumination device, comprising:
a heat dissipation device comprising:
an elongated main body having a central axis and comprising a first portion and a second portion located in sequence along the central axis,
a plurality of heat sinks arranged around the first portion in sequence along the central axis of the main body and spaced from one another, each of the heat sinks comprising a plurality of fins extending out from the first portion radially, and
an airflow channel defined between each two neighboring heat sinks; and
at least one solid-state light source provided at an end of the second portion distant from the first portion.

2. The illumination device of claim 1, wherein the number of fins of each heat sink is same as the number of fins of each other heat sink, and each fin of each heat sink is aligned with a corresponding fin of a neighboring heat sink along a direction parallel to the central axis of the main body.

3. The illumination device of claim 1, wherein the first portion of the main body is cylindrical.

4. The illumination device of claim 1, wherein the second portion of the main body is frustoconical, with the second portion tapering from the end distant from the first portion to an end of the second portion which is adjacent to the first portion, and a diameter of the end of the second portion distant from the first portion is larger than a diameter of the first portion.

5. The illumination device of claim 1, wherein the second portion of the main body comprises a first section extending up from the first portion and a second section distant from the first portion, and the at least one solid-state light source is arranged at the second section.

6. The illumination device of claim 5, wherein the second section has an end surface distant from the first section and a plurality of substantially planar side surfaces adjacent to and surrounding the end surface, and the at least one solid-state light source comprises a plurality of solid-state light sources arranged at the end surface and the side surfaces.

7. The illumination device of claim 6, wherein an angle between the end surface and each side surface is an obtuse angle.

8. The illumination device of claim 6, wherein the second section of the second portion has one of a substantially circular frustoconical shape and a substantially polygonal frustoconical shape, and each such shape tapers from an end thereof adjacent to the first section to an end thereof distant from the first section.

9. The illumination device of claim 8, wherein the second section of the second portion has a substantially polygonal frustoconical shape, and a diameter of the end of the second section adjacent to the first section is larger than a diameter of the first section.

10. The illumination device of claim 1, wherein each heat sink further comprises a sleeve contacting the first portion of the main body, and the fins of the heat sink extend out from the sleeve.

11. The illumination device of claim 1, wherein the heat dissipation device is made of material selected from the group consisting of aluminum, copper, and aluminum-copper alloy.

12. The illumination device of claim 1, wherein the at least one solid-state light source comprises at least one light emitting diode.

13. The illumination device of claim 1, wherein the at least one solid-state light source is mounted on a circuit board, and the circuit board is provided at the end of the second portion distant from the first portion.

14. A heat dissipation device, comprising:
an elongated main body having a central axis and comprising a first portion and a second portion, the second portion having an end distant from the first portion which is configured for supporting at least one item selected from the group consisting of a solid-state light source and a circuit board having a solid-state light source mounted thereon;
a plurality of heat sinks arranged around the first portion in sequence along the central axis of the main body and spaced from one another, each heat sink comprising a plurality of fins extending out from the first portion radially; and
an airflow channels defined between each two neighboring heat sinks.

15. The heat dissipation device of claim 14, wherein each heat sink further comprises a sleeve contacting the first portion of the main body, and the fins of the heat sink extend out from the sleeve.

16. The heat dissipation device of claim 14, wherein the heat dissipation device is made of material selected from the group consisting of aluminum, copper, and aluminum-copper alloy.

17. The heat dissipation device of claim 14, wherein the number of fins of each heat sink is the same as the number of fins of each other heat sink, and each fin of each heat sink is aligned with a corresponding fin of a neighboring heat sink along a direction parallel to the central axis of the main body.

18. The heat dissipation device of claim 14, wherein the second portion of the main body is frustoconical, with the second portion is tapering from the end distant from the first portion to an end of the second portion which is adjacent to the first portion, and a diameter of the end of the second portion distant from the first portion is larger than a diameter of the first portion.

19. The heat dissipation device of claim 14, wherein the second portion of the main body comprises a first section extending up from the first portion and a second section distant from the first portion, and the at least one solid-state light source is arranged at the second section.

20. The heat dissipation device of claim 19, wherein the second section has an end surface distant from the first section and a plurality of substantially planar side surfaces adjacent to and surrounding the end surface, and the at least one solid-state light source comprises a plurality of solid-state light sources arranged at the end surface and the side surfaces.
